(19) United States
(12) Patent Application Publication
(10) Pub. No.: US 2012/0064432 A1
(43) Pub. Date: Mar. 15, 2012

(54) SOLID OXIDE FUEL CELL

(75) Inventors: Eon Soo LEE, Gyeongsangbuk-do (KR); Jae Hyuk JANG, Seoul (KR); Han Wool Ryu, Seoul (KR); Jae Hyoung GIL, Seoul (KR)

(73) Assignee: SAMSUNG ELECTRO-MECHANICS CO., LTD., Gyunggi-do (KR)

(21) Appl. No.: 12/972,276

(22) Filed: Dec. 17, 2010

(30) Foreign Application Priority Data
Sep. 10, 2010 (KR) 10-2010-0088805

(51) Int. Cl. H01M 8/10

(52) U.S. Cl. 429/481

(57) ABSTRACT

Disclosed herein is a solid oxide fuel cell. A solid oxide fuel cell 100 according to the present invention is configured to include an anode support 110, a plurality of channels including a first channel 120, a second channel 130, a third channel 140, and a fourth channel 150 penetrating through the anode support 110, an electrolyte 160 formed in inner side surfaces of specific channels, and a cathode 170 formed in an inner side surface of the electrolyte 160, whereby fuel is supplied to the outside of the anode support 110 as well as the channel in which the electrolyte 160 and the cathode 170 are not formed, thereby making it possible to increase the efficiency of the solid oxide fuel cell 100.

### CROSS REFERENCE TO RELATED APPLICATION

This application claims the benefit of Korean Patent Application No. 10-2010-0088805, filed on Sep. 10, 2010, entitled “Solid Oxide Fuel Cell,” which is hereby incorporated by reference in its entirety into this application.

### BACKGROUND OF THE INVENTION

1. Technical Field

The embodiment relates to a solid oxide fuel cell.

2. Description of the Related Art

A fuel cell is an apparatus that directly converts chemical energy into electric and heat energy by electrochemical reaction of fuel (hydrogen, LNG, LPG, etc.,) and oxygen (air). The existing generation technology should perform a process such as fuel combustion, steam generation, turbine driving, generator driving, etc., while the fuel cell is a new generation technology implementing high efficiency and not leading to environmental problems since it does not perform the process such as the fuel combustion, the turbine driving, etc. The fuel cell can achieve pollution-free generation since it does not almost discharge air pollutants such as Sox and NOx, etc., and does not almost generate carbon dioxide and has advantages of low noise, non-vibration, etc.

As a type of a fuel cell, there are various fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among others, the solid oxide fuel cell (SOFC) has high generation efficiency due to low over voltage and small irreversible loss based on activation polarization. In addition, since the reaction rate is rapid in the electrode, the solid oxide fuel cell does not require expensive noble metals as an electrode catalyst. Therefore, the solid oxide fuel cell is an essential generation technology in order to entry a hydrogen economy society in the future.

FIG. 1 is a conceptual diagram showing a generation principle of a solid oxide fuel cell.

Reviewing a basic generation principle of a solid oxide fuel cell (SOFC) with reference to FIG. 1, when fuel is hydrogen (H₂) or carbon monoxide (CO), the following electrode reaction is performed in an anode 1 and a cathode 2.

Anode: CO+H₂O→H₂+CO₂

2H₂+2O²⁻→4e⁻+2H₂O

Cathode: O₂+4e⁻→2O²⁻

Entire reaction: H₂+CO+O₂→CO₂+H₂O

That is, electrons (e⁻) generated in the anode 1 are transferred to the cathode 2 through an external circuit 4 and at the same time, oxygen ions (O²⁻) generated in the cathode 2 are transferred to the anode 1 through an electrolyte 3. In addition, hydrogen (H₂) is combined with oxygen ion (O²⁻) in the anode 1 to generate electrons (e⁻) and water (H₂O). As a result, reviewing the entire reaction of the solid oxide fuel cell, hydrogen (H₂) or carbon monoxide (CO) are supplied to the anode 1 and oxygen is supplied to the cathode 2, such that carbon dioxide (CO₂) and water (H₂O) are generated.

Meanwhile, the solid oxide fuel cell may be classified into a tubular type and a planar type. However, in order to efficiently sealing gas, the tubular-type solid oxide fuel cell has been used mainly.

FIG. 2 is a perspective view of a tubular-type solid oxide fuel cell according to the prior art. As shown in FIG. 2, in the tubular-type solid oxide fuel cell 10, an electrolyte 13 and an anode 15 are sequentially stacked on the outside of a cathode support 11 and a connection member 17 for connecting with other unit cells is formed on the upper portion of the cathode support 11. As described above, the tubular solid oxide fuel cell 10 has good long-term durability and is stable against thermal impact since it does not require to seal gas, differently from the planar-type solid oxide fuel cell.

However, there is problems in that the tubular solid oxide fuel cell according to the prior art occupies a relatively large volume since it forms a bundle of unit cells by connecting the unit cells and has low output density per volume.

### SUMMARY OF THE INVENTION

The present invention has been made in an effort to provide a solid oxide fuel cell capable of increasing output density per volume by configuring unit cells by penetrating a plurality of channels through a support having a hexagonal prism shape.

A solid oxide fuel cell according to a preferred embodiment of the present invention includes: an anode support formed to have a hexagonal prism shape and having a cross section of a regular hexagon; a first channel penetrating through the anode support so that the center of the first channel coincides with the center of the anode support; six second channels penetrating through the anode support to surround the first channel, a first virtual line connecting each of the centers of the six second channels forming a concentric first regular hexagon by reducing the cross section of the anode support at a predetermined ratio; twelve third channels penetrating through the anode support to surround the second channel, a second virtual line connecting the centers of the twelve third channels forming a concentric second regular hexagon by enlarging the first regular hexagon twice; eighteen fourth channels penetrating through the anode support to surround the third channel, a third virtual line connecting the centers of the eighteen fourth channels forming a concentric third regular hexagon by enlarging the first regular hexagon three times; an electrolyte formed in the inner side surfaces of the second channel and the inner side surfaces of the fourth channel and formed in the inner side surfaces of the six third channels forming corners other than the vertices of the second regular hexagon formed by connecting the centers of the third channel; and a cathode formed in the inner side surface of the electrolyte, wherein the size and shape of the first channel, the second channel, the third channel, and the fourth channel are the same and the mutual interval thereof is the same.

The solid oxide fuel cell further includes: twenty four fifth channels penetrating through the anode support to surround the fourth channel, a fourth virtual line connecting the centers of the twenty four fifth channels forming a concentric fourth regular hexagon by enlarging the first regular hexagon four times; and thirty sixth channels penetrating through the anode support to surround the fifth channel, a fifth virtual line connecting the centers of the thirty sixth channels forming a concentric fifth regular hexagon by enlarging the first regular hexagon five times, wherein the size and shape of the first channel, the second channel, the third channel, the fourth channel, the fifth channel, and the sixth channel are the same and the mutual interval thereof is the same; and the electrolyte is further formed in the inner side surfaces of the six channel and the inner side surfaces of the twelve fifth channels forming corners other than the vertices of the fourth regular hexagon formed by connecting the centers of the fifth channel and the centers of the adjacent vertices thereof.

The cross section of the first channel, the cross section of the second channel, the cross section of the third channel, and the cross section of the fourth channel may be formed to have a circular shape.

The cross section of the first channel, the cross section of the second channel, the cross section of the third channel, and the cross section of the fourth channel may be formed to have a hexagonal shape.

The cross section of the first channel, the cross section of the second channel, the cross section of the third channel, the cross section of the fourth channel, the cross section of the fifth channel, and the cross section of the sixth channel may be formed to have a circular shape.

The cross section of the first channel, the cross section of the second channel, the cross section of the third channel, the cross section of the fourth channel, the cross section of the fifth channel, and the cross section of the sixth channel may be formed to have a hexagonal shape.

The solid oxide fuel cell may further include an anode functional layer formed between the outer side surface of the electrolyte and the anode support.

The solid oxide fuel cell may further include an anode functional layer formed between the outer side surface of the electrolyte and the anode support.

The solid oxide fuel cell may further include a cathode functional layer formed between the inner side surface of the electrolyte and the cathode.

The solid oxide fuel cell may further include a cathode functional layer formed between the inner side surface of the electrolyte and the cathode.

A solid oxide fuel cell according to another preferred embodiment of the present invention includes: a cathode support formed to have a hexagonal prism shape and having a cross section of a regular hexagon; a first channel penetrating through the cathode support so that the center of the first channel coincides with the center of the cathode support; six second channels penetrating through the cathode support to surround the first channel, a first virtual line connecting each of the centers of the six second channels forming a concentric first regular hexagon by reducing the cross section of the cathode support at a predetermined ratio; twelve third channels penetrating through the cathode support to surround the second channel, a second virtual line connecting the centers of the twelve third channels forming a concentric second regular hexagon by enlarging the first regular hexagon twice; eighteen fourth channels penetrating through the cathode support to surround the third channel, a third virtual line connecting the centers of the eighteen fourth channels forming a concentric third regular hexagon by enlarging the first regular hexagon three times; an electrolyte formed in the inner side surfaces of the second channel and the inner side surfaces of the fourth channel and formed in the inner side surfaces of the six third channels forming corners other than the vertices of the second regular hexagon formed by connecting the centers of the third channel; and an anode formed in the inner side surface of the electrolyte, wherein the size and shape of the first channel, the second channel, the third channel, and the fourth channel are the same and the mutual interval thereof is the same.

The solid oxide fuel cell may further include: twenty four fifth channels penetrating through the cathode support to surround the fourth channel, a fourth virtual line connecting the centers of the twenty four fifth channels forming a concentric fourth regular hexagon by enlarging the first regular hexagon four times; and thirty sixth channels penetrating through the cathode support to surround the fifth channel, a fifth virtual line connecting the centers of the thirty sixth channels forming a concentric five regular hexagon by enlarging the first regular hexagon five times, wherein the size and shape of the first channel, the second channel, the third channel, the fourth channel, the fifth channel, and the sixth channel are the same and the mutual interval thereof is the same; and the electrolyte is further formed in the inner side surfaces of the six channel and the inner side surfaces of the twelve fifth channels forming corners other than the vertices of the fourth regular hexagon formed by connecting the centers of the fifth channel and the centers of the adjacent vertices thereof.

The cross section of the first channel, the cross section of the second channel, the cross section of the third channel, and the cross section of the fourth channel may be formed to have a circular shape.

The cross section of the first channel, the cross section of the second channel, the cross section of the third channel, and the cross section of the fourth channel may be formed to have a hexagonal shape.

The cross section of the first channel, the cross section of the second channel, the cross section of the third channel, the cross section of the fourth channel, the cross section of the fifth channel, and the cross section of the sixth channel may be formed to have a circular shape.

The cross section of the first channel, the cross section of the second channel, the cross section of the third channel, the cross section of the fourth channel, the cross section of the fifth channel, and the cross section of the sixth channel may be formed to have a hexagonal shape.

The solid oxide fuel cell may further include a cathode functional layer formed between the outer side surface of the electrolyte and the cathode support.

The solid oxide fuel cell may further include a cathode functional layer formed between the outer side surface of the electrolyte and the cathode support.

The solid oxide fuel cell may further include an anode functional layer formed between the inner side surface of the electrolyte and the anode.

The solid oxide fuel cell may further include an anode functional layer formed between the inner side surface of the electrolyte and the anode.

### BRIEF DESCRIPTION OF THE DRAWINGS

FIG. 1 is a conceptual diagram showing a generation principle of a solid oxide fuel cell;

FIG. 2 is a perspective view of a tubular-type solid oxide fuel cell according to the prior art;

FIGS. 3 and 4 are cross-sectional views of a solid oxide fuel cell according to a first preferred embodiment of the present invention;

FIGS. 5 and 6 are cross-sectional views of a solid oxide fuel cell according to a second preferred embodiment of the present invention;

FIGS. 7 and 8 are cross-sectional views of a solid oxide fuel cell according to a third preferred embodiment of the present invention; and

FIGS. 9 and 10 are cross-sectional views of a solid oxide fuel cell according to a fourth preferred embodiment of the present invention.

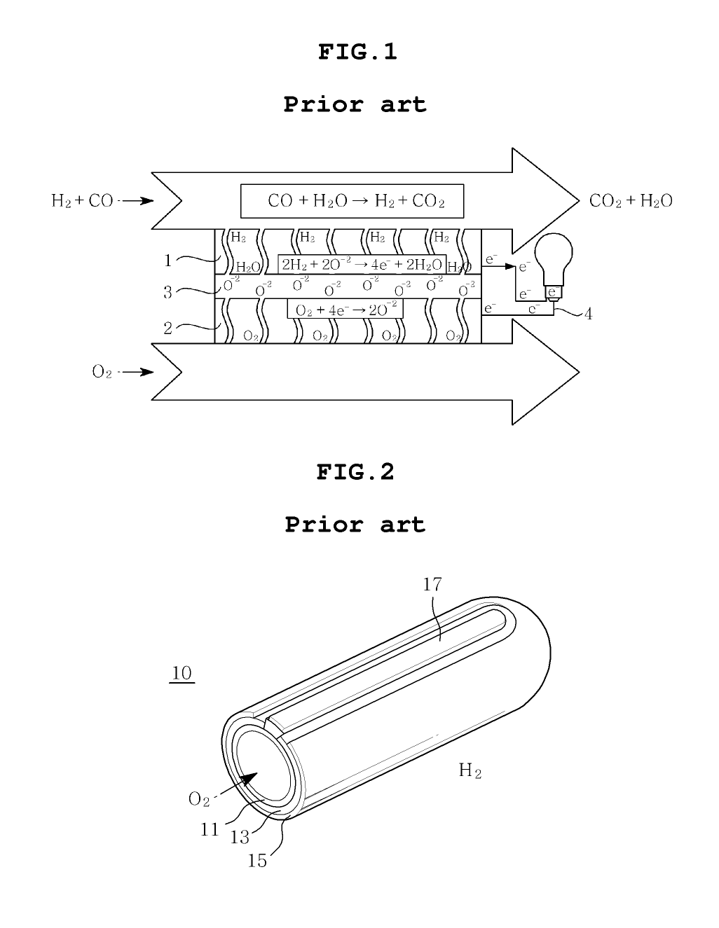

### DESCRIPTION OF THE PREFERRED EMBODIMENTS

Various objects, advantages and features of the invention will become apparent from the following description of the embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Terms used in the specification, ‘first’, ‘second’, ‘third’, ‘fourth’, etc., can be used to describe various components, but the components are not to be construed as being limited to the terms. The terms are only used to differentiate one component from other components. Further, in describing the present invention, a detailed description of related known functions or configurations will be omitted so as not to obscure the subject of the present invention. Further, when it is determined that the detailed description of the known art related to the present invention may obscure the gist of the present invention, the detailed description will be omitted.

Hereinafter, preferred embodiments of the present invention will be described in detail with reference to the accompanying drawings.

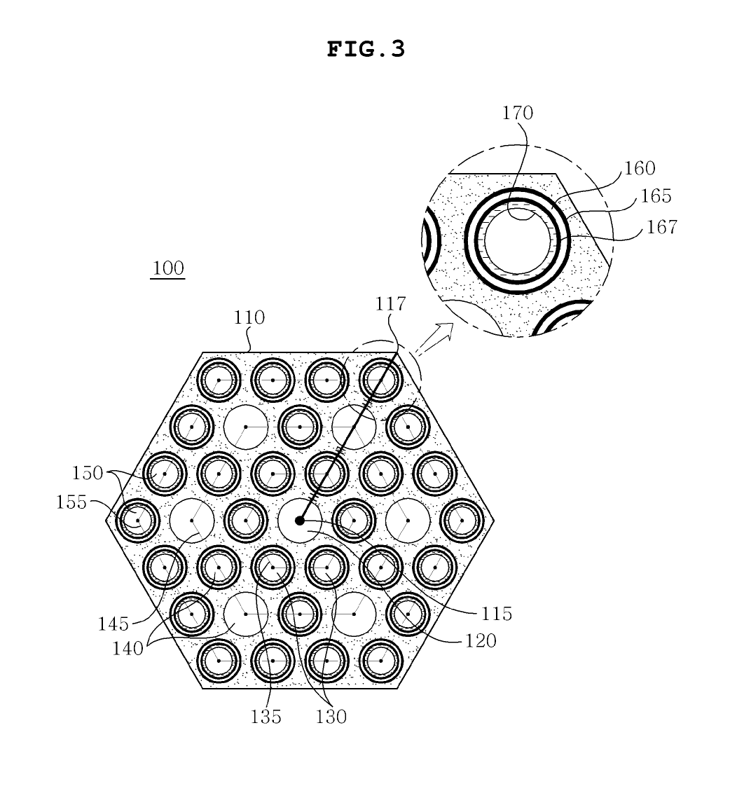

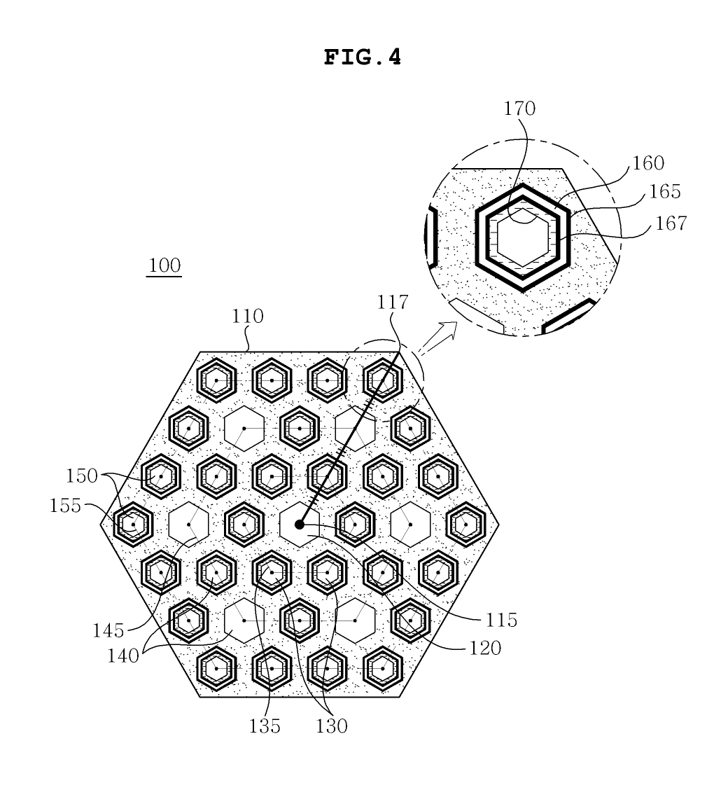

FIGS. 3 and 4 are cross-sectional views of a solid oxide fuel cell according to a first preferred embodiment of the present invention.

As shown in FIGS. 3 and 4, a solid oxide fuel cell 100 according to a first preferred embodiment is configured to include an anode support 110, a plurality of channels including a first channel 120, a second channel 130, a third channel 140, and a fourth channel 150 penetrating through the anode support 110, an electrolyte 160 formed in inner side surfaces of specific channels, and a cathode 170 formed in an inner side surface of the electrolyte 160.

The anode support 110, which is a fundamental member of the solid oxide fuel cell 100, supports the electrolyte 160 and the cathode 170 and is supplied with fuel to serve as an anode by electrode reaction. The anode support 110 may be formed to have a hexagonal prism shape so that a cross section of the anode support 110 is a regular hexagon by an extrusion process, etc., and have porosity to effectively diffuse fuel. In addition, the anode support 110 is made of nickel oxide (NiO) and yttria stabilized zirconia (YSZ). When fuel is supplied to the anode support 110, the nickel oxide is reduced to metal nickel by hydrogen among fuels to show electronic conductivity and the yttria stabilized zirconia (YSZ) is an oxide to show ion conductivity.

The plurality of channels are divided into the first channel 120, the second channel 130, the third channel 140, and the fourth channel 150 and are formed to longitudinally penetrate through the anode support 110. In this configuration, the first channel 120 is disposed so that its center coincides with the center 115 of the anode support 110 and a virtual line connecting the centers of the second channel 130, the third channel 140, and the fourth channel 150 forms a regular hexagon to sequentially surround the first channel 120. In addition, the first channel 120, the second channel 130, the third channel 140, and the fourth channel 150 have the same size and shape and the mutual interval thereof is also the same.

More specifically reviewing the plurality of channels, the first channel 120 penetrates through the anode support 110 so that its center coincides with the center 115 of the anode support 110. In this configuration, the center 115 of the anode support 110 implies an intersecting point of three lines connecting two vertices facing each other at the regular hexagon that is a cross section of the anode support 110. Therefore, the first channel 120 is disposed at the exact center of the anode support 110.

The second channel 130 penetrates through the anode support 110 to surround the first channel 120. In this configuration, the second channel 130 is six and a first virtual line connecting each center forms a first regular hexagon 135 by reducing the cross section of the anode support 110, i.e., the regular hexagon at a predetermined ratio. In this case, the centers of the first regular hexagon 135 coincide with the centers of the regular hexagon (the cross section of the anode support 110) (concentric) and the vertices of the first regular hexagon 135 is disposed on a line connecting the center 115 of the anode support 110 and the vertices 117 on the cross section of the anode support 110.

The third channel 140 penetrates through the anode support 110 to surround the second channel 120. In this case, the third channel 140 is twelve and the second virtual line connecting each center forms a second regular hexagon 145 by enlarging the first regular hexagon 135 twice. In this case, the centers of the second regular hexagon 145 coincide with the centers of the regular hexagon (concentric) and the vertices of the second regular hexagon 145 are disposed on a line connecting the center 115 of the anode support 110 and the vertices 117 on the cross section of the anode support 110.

The fourth channel 150 penetrates through the anode support 110 to surround the third channel 140. In this case, the fourth channel 150 is eighteen and the third virtual line connecting each center forms a third regular hexagon 155 by enlarging the first regular hexagon 135 three times. In this case, the centers of the third regular hexagon 155 coincide with the centers of the first regular hexagon (concentric) and the vertices of the third regular hexagon 155 are disposed on a line connecting the center 115 of the anode support 110 and the vertices 117 on the cross section of the anode support 110.

Meanwhile, the cross section of the first channel 120, the cross section of the second channel 130, the cross section of the third channel 140, and the cross section of the fourth channel 150 may be formed to have a circular shape (see FIG. 3). It is possible to easily machine the channel by forming the cross section of the channel in a circular shape and to minimize friction generated when gas flows in the channel.

However, the cross section of the first channel 120, the cross section of the second channel 130, the cross section of the third channel 140, and the cross section of the fourth channel 150 are not necessarily formed to have a circular shape and therefore, may be formed to have a hexagonal shape (see FIG. 4). The interval between the channels may be reduced by forming the cross section of the channel in a hexagonal shape, thereby making it possible to maximize the reaction area.

The electrolyte 160 serves to transfer the oxygen ion generated in the cathode 170 to the anode support 110. In this case, the electrolyte 160 may be formed by coating the yttria stabilized zirconia (YSZ) or scandium stabilized zirconia (ScSZ), GDC, LDC, etc., by a drying method such as a plasma spray method, an electrochemical deposition method, a sputtering method, an ion beam method, a ion injection method, etc., or a wetting method such as a tape casting method, a spray coating method, a dip coating method, a screen printing method, a doctor blade method, or the like, and then sintering them at 1300 to 1500. In this case, in the yttria stabilised zirconia, since a portion of tetravalent zirconium ions is substituted for trivalent yttrium ions, one oxygen ion hole per two yttrium ions is generated therein and oxygen ions move through the hole at high temperature. Meanwhile, since the electrolyte 160 is a solid electrolyte, it has low ion conductivity as compared to the liquid electrolyte such as an aqueous solution or a melting salt to reduce voltage drop caused due to resistance polarization. Therefore, it is preferable to form the electrolyte 160 as thinly as possible. In addition, when pores are generated in the electrolyte 160, it is to be noted that scratch is not generated since the efficiency is degraded due to the occurrence of a crossover phenomenon of directly reacting fuel with air.

Meanwhile, the electrolyte 160 is formed in the inner side surfaces of the first channel 120, the second channel 130, the third channel 140, and the fourth channel 150. In detail, both the inner side surfaces of the second channel 130 and the inner side surfaces of the fourth channel 150 are provided with the electrolyte 160 but the inner side surfaces of the first channel 120 are not provided with the electrolyte 160. In addition, the case of the third channel 140, only the inner side surfaces of the six third channels 140 forming corners other than the vertices of the second regular hexagon 145 are provided with the electrolyte 160. That is, the inner side surfaces of the first channel 120 and the inner side surfaces of the third channel 140 forming the vertices of the second regular hexagon 145 formed by connecting the centers of the third channel 140 are not provided with the electrolyte 160. Therefore, reviewing the disposition relation of the entire channel, a structure where six channels provided with the electrolyte 160 surround one channel not provided with the electrolyte 160 is formed. The efficiency of the solid oxide fuel cell 100 may be increased through the above-mentioned disposition relation and therefore, the detailed description thereof will be described below.

The cathode 170 is supplied with air to serve as an anode through the electrode reaction and is formed in the inner side surface of the electrolyte 160. In this case, the cathode 170 may be formed by coating lanthanum strontium manganite ((La_{0.84}Sr_{0.16})MnO₃), etc., having high electronic conductivity by a dry method and a wet method like the electrolyte 160 and then sintering it at 1200 to 1300. Meanwhile, oxygen in the air is converted to oxygen ion by the catalyst operation of the lanthanum strontium manganite in the cathode 170, which is transferred to the anode support 110 through the electrolyte 160.

Reviewing the entire disposition relation of the entire channel, a structure where six channels provided with the electrolyte 160 and the cathode 170 surround one channel not provided with the electrolyte 160 and the cathode 170 is formed. Therefore, when fuel is supplied to the channel where the electrolyte 160 and the cathode 170 are not formed, fuel is effectively diffused in six channel directions through the porous anode support 110. As a result, the solid oxide fuel cell 100 according to the first preferred embodiment supplies fuel to the outside of the anode support 110 as well as the channel in which the electrolyte 160 and the cathode 170 are not formed, thereby making it possible to increase the efficiency of the solid oxide fuel cell 100.

Meanwhile, an anode functional layer 165 may be formed between the outer side surface of the electrolyte 160 and the anode support 110. In this configuration, the anode functional layer 165 serves to supplement the electrochemical activation of the anode support 110. Therefore, the anode functional layer 165 may be formed using the nickel oxide (NiO) and the yttria stabilized zirconia (YSZ), similar to the anode support 110. However, in order to reinforce the electrochemical activation, the anode functional layer 165 may be formed using fine yttria stabilized zirconia, not coarse yttria stabilized zirconia. Meanwhile, since the anode functional layer 165 performs a buffer role for forming the electrolyte 160 in the anode support 110, it is preferable to minimize the surface roughness while having low porosity.

In addition, the cathode functional layer 167 may be formed between the inner side surface of the electrolyte 160 and the cathode 170. In this configuration, the cathode functional layer 167 serves to supplement the electrochemical activation of the cathode 170. Therefore, the cathode functional layer 167 may be formed using the composite between the material forming the cathode 170 and the material forming the electrolyte 160. For example, the cathode functional layer 167 may be formed using the composite of the lanthanum strontium manganite forming the cathode 170 and the yttria stabilized zirconia forming the electrolyte 160. Meanwhile, the cathode functional layer 167 performs a buffer role between the electrolyte 160 and the cathode 170, similar to the anode functional layer 165.

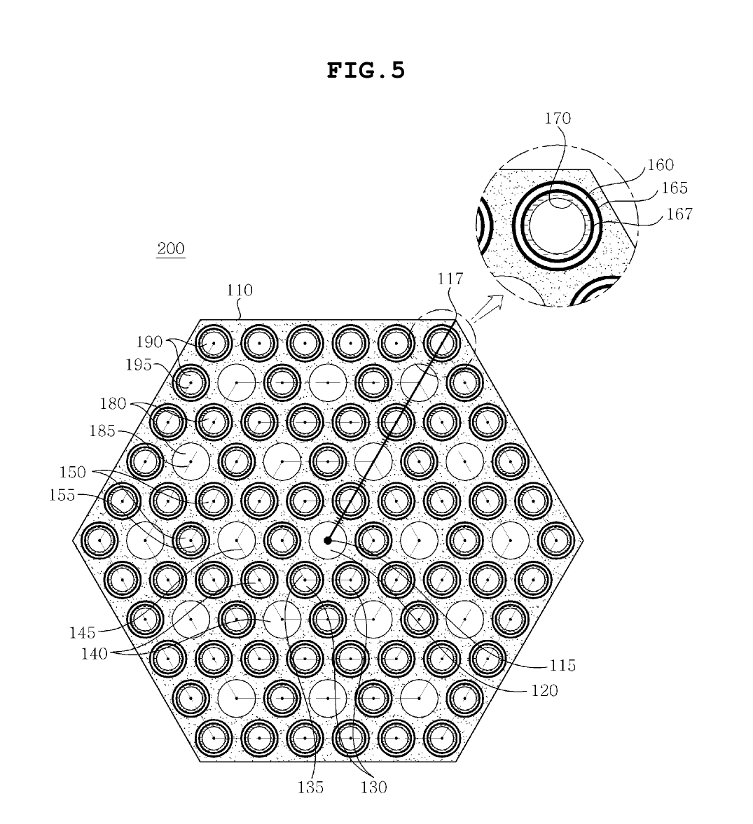

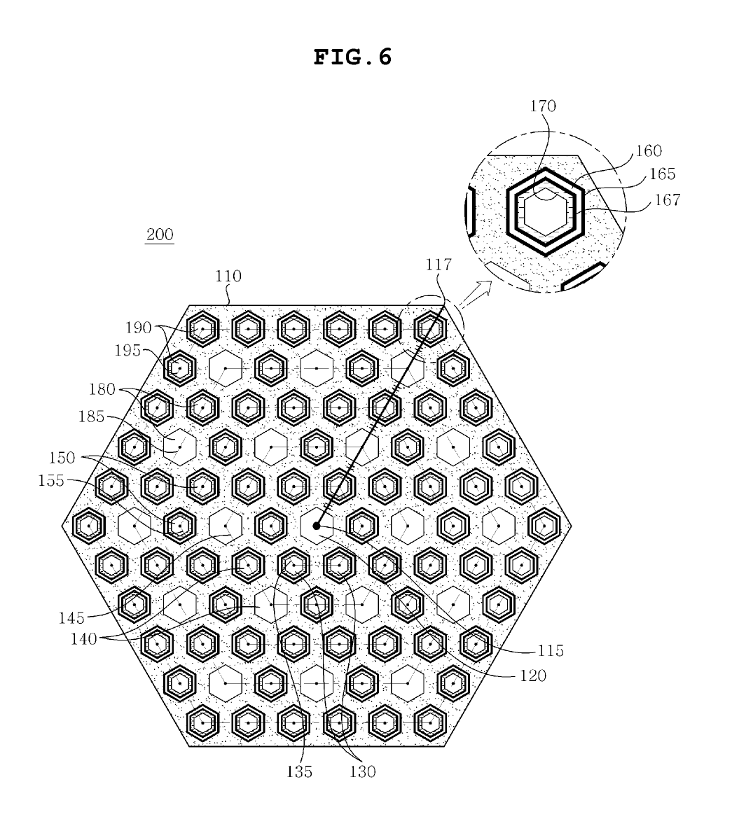

FIGS. 5 and 6 are cross-sectional views of a solid oxide fuel cell according to a second preferred embodiment of the present invention.

As shown in FIGS. 5 and 6, a solid oxide fuel cell 200 according to the second preferred embodiment is configured to include an anode support 110, a plurality of channels including a first channel 120, a second channel 130, a third channel 140, a fourth channel 150, a fifth channel 180, and a sixth channel 190 penetrating through the anode support 110, an electrolyte 160 formed in inner side surfaces of specific channels, and a cathode 170 formed in an inner side surface of the electrolyte 160.

Comparing the second preferred embodiment with the above-mentioned first preferred embodiment, the solid oxide fuel cell 200 according to the second preferred embodiment is configured by adding the fifth channel 180 and the sixth channel 190 to the solid oxide fuel cell 100 according to the first preferred embodiment. Therefore, the fifth channel 180 and the sixth channel 190 will be described in detail and the repeated content as the first preferred embodiment will be omitted.

The added fifth channel 180 and sixth channel 190 in the second preferred embodiment have the same size and shape as the first channel 120, the second channel 130, the third channel 140, and the fourth channel 150 and the mutual interval thereof is also the same. In addition, the cross section of the fifth channel 180 and the cross section of the sixth channel 190 may be formed to have a circular shape (see FIG. 5) or a hexagonal shape (see FIG. 6), similar to the first channel 120, the second channel 130, the third channel 140, and the fourth channel 150.

The fifth channel 180 penetrates through the anode support 110 to surround the fourth channel 150. In this configuration, the fifth channel 180 is twenty four and a fourth virtual line connecting each center forms a fourth regular hexagon 185 formed by enlarging the first regular hexagon 135 four times. In this case, the centers of the fourth regular hexagon 185 are the same as the centers of the first regular hexagon 135 (concentric) and the vertices of the fourth regular hexagon 185 are disposed on the line connecting the center 115 of the anode support 110 to the vertices 117 on the cross section of the anode support 110.

The sixth channel 190 penetrates through the anode support 110 to surround the fifth channel 180. In this configuration, the fifth channel 180 is thirty and a fifth virtual line connecting each center forms a fifth regular hexagon 195 formed by enlarging the first regular hexagon 135 fifth times. In this case, the centers of the fifth regular hexagon 195 are the same as the centers of the first regular hexagon 135 (concentric) and the vertices of the fifth regular hexagon 195 are disposed on the line connecting the center 115 of the anode support 110 to the vertices 117 on the cross section of the anode support 110.

In this case, the electrolyte 160 is further formed in the inner side surfaces of the fifth channel 180 and the sixth channel 190. In detail, all the inner side surfaces of the sixth channel 190 are provided with the electrolyte 160 but in the case of the fifth channel 180, only the inner side surfaces of the twelve fifth channels 180 forming corners other than the vertices of the fourth regular hexagon 185 and the centers between the vertices thereof are provided with the electrolyte 160. In other words, the inner side surfaces of the fifth channel 180 forming the vertices of the fourth regular hexagon 185 formed by connecting the centers of the fifth channel are not provided with the electrolyte 160. Therefore, reviewing the entire disposition relation of the entire channel, a structure where six channels provided with the electrolyte 160 and the cathode 170 surround one channel not provided with the electrolyte 160 and the cathode 170 is formed, similar to the solid oxide fuel cell 100 according to the first preferred embodiment. As a result, when fuel is supplied to the channel where the electrolyte 160 and the cathode 170 are not formed, fuel is effectively diffused in six channel directions surrounding the channel where the electrolyte 160 and the cathode 170 are not formed, through the porous anode support 110. The solid oxide fuel cell 200 according to the second preferred embodiment supplies fuel to the outside of the anode support 110 as well as the channel in which the electrolyte 160 and the cathode 170 are not formed, thereby making it possible to increase the efficiency of the solid oxide fuel cell 200.

Meanwhile, the inner side surface of the electrolyte 160 formed in the inner side surfaces of the fifth channel 180 and the sixth channel 190 is provided with the cathode 170. In addition, the anode functional layer 165 may be formed between the outer side surface of the electrolyte 160 and the anode support 110 and the cathode functional layer 167 may be formed between the inner side surface of the electrolyte 160 and the cathode 170.

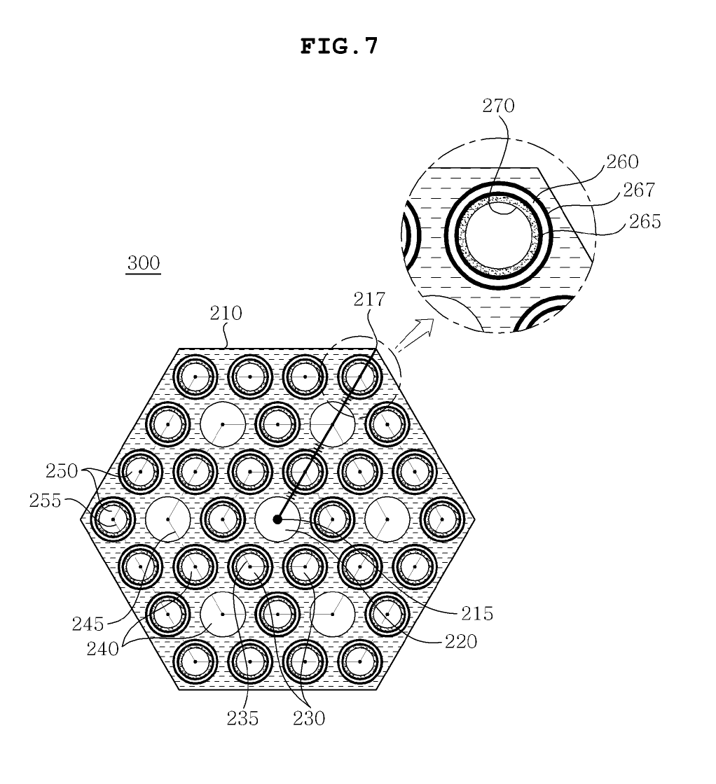

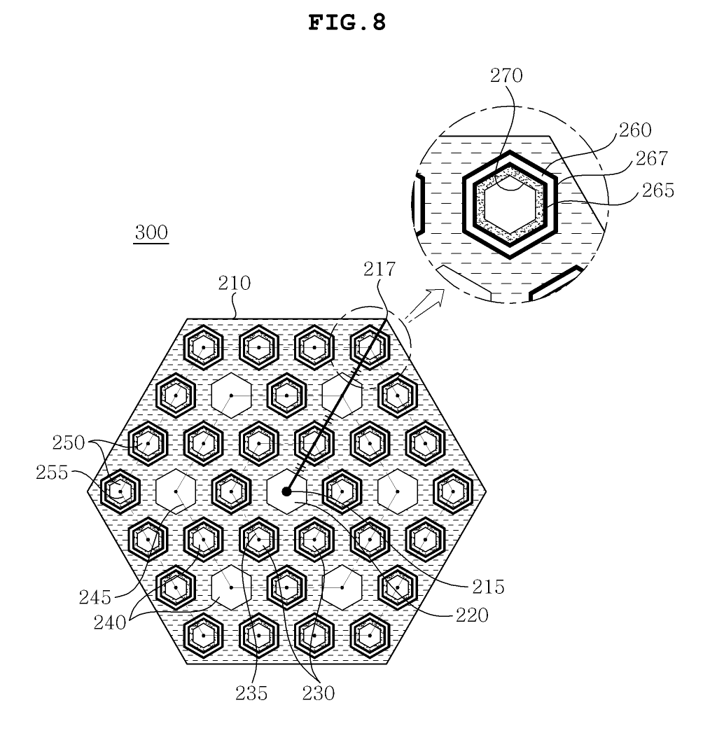

FIGS. 7 and 8 are cross-sectional views of a solid oxide fuel cell according to a third preferred embodiment of the present invention.

As shown in FIGS. 7 and 8, a solid oxide fuel cell 300 according to the third preferred embodiment is configured to include a cathode support 210, a plurality of channels including a first channel 220, a second channel 230, a third channel 240, and a fourth channel 250 penetrating through the cathode support 210, an electrolyte 260 formed in inner side surfaces of specific channels, and a cathode 270 formed in an inner side surface of the electrolyte 260.

Comparing the third preferred embodiment with the above-mentioned first preferred embodiment, in the solid oxide fuel cell 300 according to the third preferred embodiment, it can appreciate the difference between the case where the anode support 110 is substituted into the cathode support 210 and the case where the cathode 170 is substituted into the anode 270. Therefore, the difference will be mainly described herein and the repeated content as the first preferred embodiment will be omitted.

The cathode support 210, which is a fundamental member of the solid oxide fuel cell 300, supports the electrolyte 260 and the cathode 270 and is supplied with air to serve as an anode by electrode reaction. The cathode support 210 may be formed to have a hexagonal prism shape so that a cross section of the cathode support 210 is a regular hexagon by an extrusion process, etc., and have porosity to effectively diffuse air. In addition, the cathode support 210 may be made of lanthanum strontium manganite ((La_{0.84}Sr_{0.16})MnO₃), etc., having high electronic conductivity. Meanwhile, oxygen in the air is converted to oxygen ion by the catalyst operation of the lanthanum strontium manganite in the cathode support 210, which is transferred to the anode support 270 through the electrolyte 260.

The plurality of channels are divided into the first channel 220, the second channel 230, the third channel 240, and the fourth channel 250 and formed to longitudinally penetrate through the cathode support 210. In this case, the first channel 220 is disposed so that the center thereof coincides with the center 215 of the cathode support 210 and the virtual line connecting the centers of the second channel 230, the third channel 240, and the fourth channel 250 forms the regular hexagon to sequentially surround the first channel 220. In addition, the first channel 220, the second channel 230, the third channel 240, and the fourth channel 250 have the same size and shape and the mutual interval thereof is also the same.

Specifically reviewing the plurality of channels, the first channel 220 penetrates through the cathode support 210 so that its center coincides with the center of the cathode support 210. In this configuration, the center 215 of the cathode support 210 implies an intersecting point of three lines connecting two vertices facing each other at the regular hexagon that is a cross section of the cathode support 210. Therefore, the first channel 220 is disposed at the exact center of the cathode support 210.

The second channel 230 penetrates through the cathode support 210 to surround the first channel 220. In this configuration, the second channel 230 is six and a first virtual line connecting each center forms a first regular hexagon 235 by reducing the cross section of the cathode support 210, i.e., the regular hexagon at a predetermined ratio. In this case, the centers of the first regular hexagon 235 coincide with the centers of the regular hexagon (the cross section of the anode support 210) (concentric) and the vertices of the first regular hexagon 235 are disposed on a line connecting the center 215 of the cathode support 210 and the vertices 117 on the cross section of the cathode support 210.

The third channel 240 penetrates through the cathode support 210 to surround the second channel 230. In this configuration, the third channel 240 is twelve and a second virtual line connecting each center forms a second regular hexagon 245 formed by enlarging the first regular hexagon 235 twice. In this case, the centers of the second regular hexagon 245 are the same as the centers of the first regular hexagon 235 (concentric) and the vertices of the second regular hexagon 245 are disposed on the line connecting the center 215 of the anode support 210 to the vertices 217 on the cross section of the cathode support 210.

The fourth channel 250 penetrates through the cathode support 210 to surround the third channel 240. In this configuration, the fourth channel 250 is eighteen and a third virtual line connecting each center forms a third regular hexagon 255 formed by enlarging the first regular hexagon 235 three times. In this case, the centers of the third regular hexagon 255 are the same as the centers of the first regular hexagon 235 (concentric) and the vertices of the third regular hexagon 255 are disposed on the line connecting the center 215 of the anode support 210 to the vertices 217 on the cross section of the cathode support 210.

Meanwhile, the cross section of the first channel 220, the cross section of the second channel 230, the cross section of the third channel 240, and the cross section of the fourth channel 250 may be formed to have a circular shape (see FIG. 7). It is possible to easily machine the channel by forming the cross section of the channel in a circular shape and to minimize friction generated when gas flows in the channel.

Meanwhile, the cross section of the first channel 220, the cross section of the second channel 230, the cross section of the third channel 240, and the cross section of the fourth channel 250 are not necessarily formed to have a circular shape and therefore, may be formed to have a hexagonal shape (see FIG. 8). The interval between the channels may be reduced by forming the cross section of the channel in a hexagonal shape, thereby making it possible to maximize the reaction area.

The electrolyte 260 serves to transfer the oxygen ion generated in the cathode support 210 to the anode 270 In this case, the electrolyte 260 may be formed by coating the yttria stabilized zirconia (YSZ) or scandium stabilized zirconia (ScSZ), GDC, LDC, etc., by a drying method such as a plasma spray method, an electrochemical deposition method, a sputtering method, an ion beam method, a ion injection method, etc., or a wetting method such as a tape casting method, a spray coating method, a dip coating method, a screen printing method, a doctor blade method, or the like, and then sintering them at 1300 to 1500. In this case, in the yttria stabilized zirconia, since a portion of tetravalent zirconium ions is substituted for trivalent yttrium ions, one oxygen hole per two yttrium ions is generated therein and oxygen ions move through the hole at high temperature. Meanwhile, since the electrolyte 260 is a solid electrolyte, it has low ion conductivity as compared to the liquid electrolyte such as an aqueous solution or a melting salt to reduce voltage drop caused due to resistance polarization. Therefore, it is preferable to form the electrolyte 260 as thinly as possible. In addition, when pores are generated in the electrolyte 260, it is to be noted that scratch is not generated since the efficiency is degraded due to the occurrence of a crossover phenomenon of directly reacting fuel with air.

Meanwhile, the electrolyte 260 is formed in the inner side surfaces of the first channel 220, the second channel 230, the third channel 240, and the fourth channel 250. In detail, both the inner side surfaces of the second channel 230 and the inner side surfaces of the fourth channel 250 are provided with the electrolyte 260 but the inner side surfaces of the first channel 220 are not provided with the electrolyte 260. In addition, in the case of the third channel 240, only the inner side surfaces of the six third channels 240 forming corners other than the vertices of the second regular hexagon 245 are provided with the electrolyte 260. That is, the inner side surfaces of the first channel 220 and the inner side surfaces of the third channel 240 forming the vertices of the second regular hexagon 245 formed by connecting the centers of the third channel 240 are not provided with the electrolyte 260. Therefore, reviewing the disposition relation of the entire channel, a structure where six channels provided with the electrolyte 260 surround one channel not provided with the electrolyte 260 is formed. The efficiency of the solid oxide fuel cell 300 may be increased through the above-mentioned disposition relation and therefore, the detailed description thereof will be described below.

The anode 270 is supplied with fuel to serve as an anode through the electrode reaction and is formed in the inner side surface of the electrolyte 260. In this case, the anode 270 may be formed by being coated and then being heated at 1200 to 1300 by a dry method or a wet method, similar to the electrolyte 260. In this case, the anode 270 is formed using the nickel oxide (NiO) and the yttria stabilized zirconia (YSZ). The nickel oxide is reduced to the metal nickel by hydrogen among fuels to show the electronic conductivity and the yttria stabilized zirconia (YSZ) shows the ion conductivity as oxide.

Reviewing the disposition relation of the entire channel, a structure where six channels provided with the electrolyte 260 and the anode 270 surround one channel not provided with the electrolyte 260 and the anode 270 is formed. Therefore, when air is supplied to the channel where the electrolyte 260 and the anode 270 are not formed, air is effectively diffused in six channel directions surrounding the channel through the porous cathode support 210. As a result, the solid oxide fuel cell 300 according to the first preferred embodiment supplies air to the outside of the cathode support 210 as well as the channel in which the electrolyte 260 and the anode 270 are not formed, thereby making it possible to increase the efficiency of the solid oxide fuel cell 300.

Meanwhile, the cathode functional layer 267 may be formed between the outer side surface of the electrolyte 260 and the cathode support 210 and the anode functional layer 265 may be formed between the inner side surface of the electrolyte 260 and the anode 270.

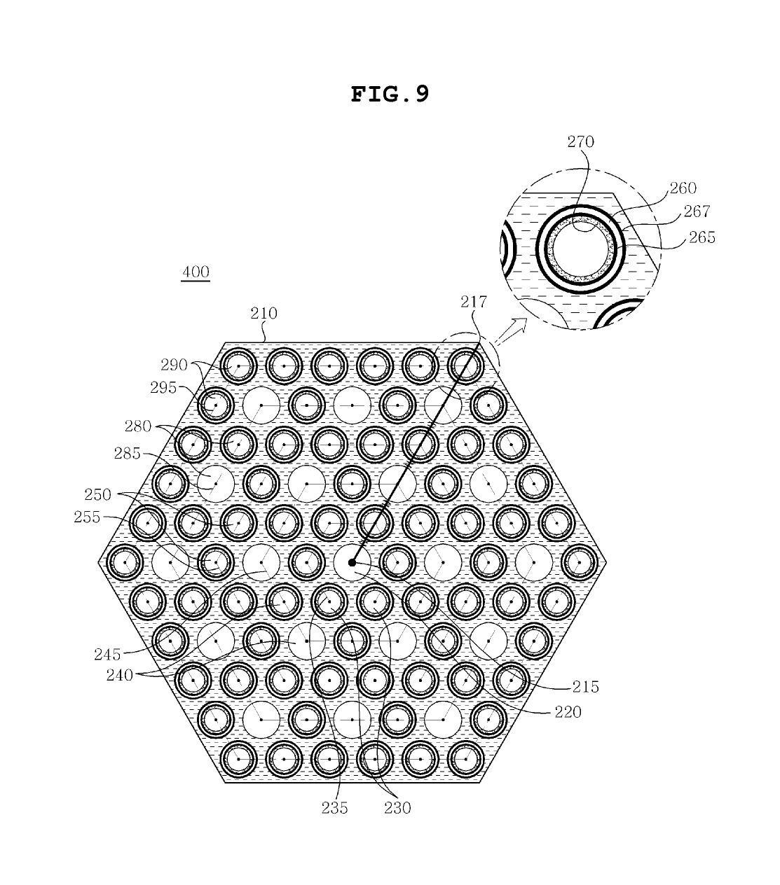

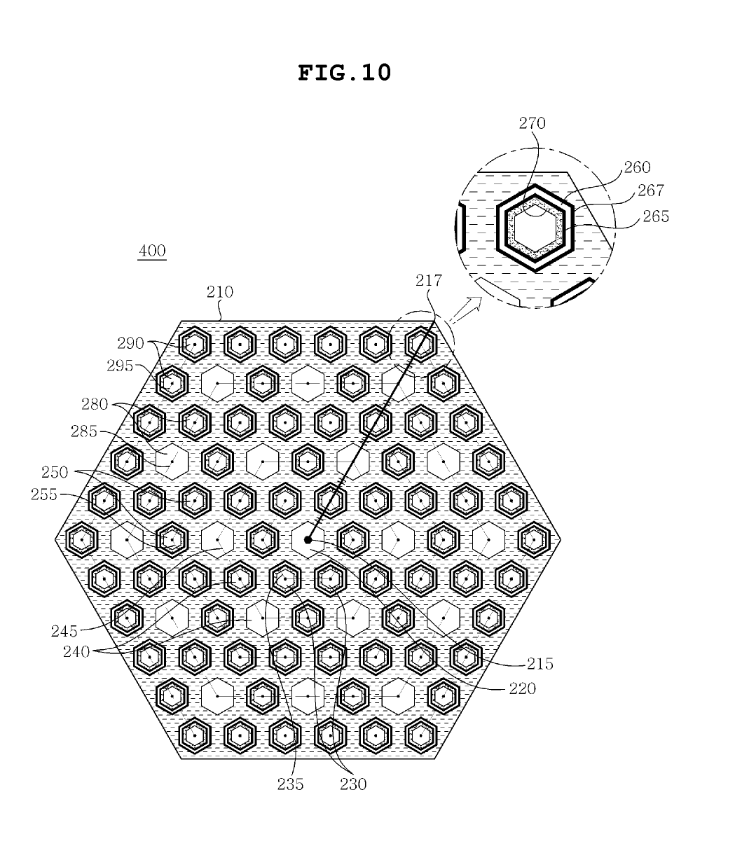

FIGS. 9 and 10 are cross-sectional views of a solid oxide fuel cell according to a fourth preferred embodiment of the present invention.

As shown in FIGS. 9 and 10, a solid oxide fuel cell 400 according to the fourth preferred embodiment is configured to include the cathode support 210, the plurality of channels including the first channel 220, the second channel 230, the third channel 240, the fourth channel 250, the fifth channel 280, and the sixth channel 290 penetrating through the cathode support 210, the electrolyte 260 formed in the inner side surfaces of the specific channels, and the anode 270 formed in the inner side surface of the electrolyte 260.

Comparing the fourth preferred embodiment with the above-mentioned third preferred embodiment, the solid oxide fuel cell 400 according to the fourth preferred embodiment is configured by adding the fifth channel 280 and the sixth channel 290 to the solid oxide fuel cell 300 according to the first preferred embodiment. Therefore, the fifth channel 280 and the sixth channel 290 will be described in detail and the repeated content as the third preferred embodiment will be omitted.

The added fifth channel 280 and sixth channel 290 in the fourth preferred embodiment have the same size and shape as the first channel 220, the second channel 230, the third channel 240, and the fourth channel 250 and the mutual interval thereof is also the same. In addition, the cross section of the fifth channel 280 and the cross section of the sixth channel 290 may be formed to have a circular shape (see FIG. 9) or a hexagonal shape (see FIG. 10), similar to the first channel 220, the second channel 230, the third channel 240, and the fourth channel 250.

The fifth channel 280 penetrates through the cathode support 210 to surround the fourth channel 250. In this configuration, the fifth channel 280 is twenty four and a fourth virtual line connecting each center forms a fourth regular hexagon 285 formed by enlarging the first regular hexagon 235 four times. In this case, the centers of the fourth regular hexagon 285 are the same as the centers of the first regular hexagon 235 (concentric) and the vertices of the fourth regular hexagon 285 are disposed on the line connecting the center 215 of the anode support 210 to the vertices 217 on the cross section of the cathode support 210.

The sixth channel 290 penetrates through the cathode support 210 to surround the fifth channel 280. In this configuration, the fifth channel 280 is thirty and a fifth virtual line connecting each center forms a fifth regular hexagon 295 formed by enlarging the first regular hexagon 235 fifth times. In this case, the centers of the fifth regular hexagon 295 are the same as the centers of the first regular hexagon 235 (concentric) and the vertices of the fifth regular hexagon 295 are disposed on the line connecting the center 215 of the anode support 210 to the vertices 217 on the cross section of the cathode support 210.

In this case, the electrolyte 260 is further formed in the inner side surfaces of the fifth channel 280 and the sixth channel 290. In detail, all the inner side surfaces of the sixth channel 290 are provided with the electrolyte 260 but in the case of the fifth channel 280, only the inner side surfaces of the twelve fifth channels 280 forming corners other than the vertices of the fourth regular hexagon 285 and the centers between the vertices thereof are provided with the electrolyte 260. In other words, the inner side surfaces of the fifth channel 280 forming the vertices of the fourth regular hexagon 285 and the centers of the two adjacent vertices thereof are not provided with the electrolyte 260. Therefore, reviewing the entire disposition relation of the entire channel, a structure where six channels provided with the electrolyte 260 and the anode 270 surround one channel not provided with the electrolyte 260 and the anode 270 is formed, similar to the solid oxide fuel cell 300 according to the third preferred embodiment. As a result, when air is supplied to the channel where the electrolyte 260 and the anode 270 are not formed, air is effectively diffused in six channel directions surrounding the channel where the electrolyte 260 and the anode 270 are not formed, through the porous anode support 210. As a result, the solid oxide fuel cell 400 according to the first preferred embodiment supplies air to the outside of the cathode support 210 as well as the channel in which the electrolyte 260 and the anode 270 are not formed, thereby making it possible to increase the efficiency of the solid oxide fuel cell 400.

Meanwhile, the inner side surface of the electrolyte 260 formed in the inner side surfaces of the fifth channel 280 and the sixth channel 290 is provided with the anode 270. In addition, the cathode functional layer 267 may be formed between the outer side surface of the electrolyte 260 and the cathode support 210 and the anode functional layer 265 may be formed between the inner side surface of the electrolyte 260 and the anode 270.

According to the present invention, the unit cells are configured by penetrating the plurality of channels through the support having a hexagonal prism shape to increase the area of the electrolyte in which the electrochemical reaction is performed, thereby making it possible to increase the output density per volume.

Further, according to the present invention, a portion of the plurality of channels is supplied with fuel (in the case of the anode support) or air (in the case of the cathode support) without forming the electrolyte, thereby making it possible to increase the efficiency of the solid oxide fuel cell.

Although the preferred embodiments of the present invention have been disclosed for illustrative purposes, they are for specifically explaining the present invention and thus a solid oxide fuel cell according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A solid oxide fuel cell, comprising:
an anode support formed to have a hexagonal prism shape and having a cross section of a regular hexagon;
a first channel penetrating through the anode support so that the center of the first channel coincides with the center of the anode support;
six second channels penetrating through the anode support to surround the first channel, a first virtual line connecting each of the centers of the six second channels forming a concentric first regular hexagon by reducing the cross section of the anode support at a predetermined ratio;
twelve third channels penetrating through the anode support to surround the second channel, a second virtual line connecting the centers of the twelve third channels forming a concentric second regular hexagon by enlarging the first regular hexagon twice;
eighteen fourth channels penetrating through the anode support to surround the third channel, a third virtual line connecting the centers of the eighteen fourth channels forming a concentric third regular hexagon by enlarging the first regular hexagon three times;
an electrolyte formed in the inner side surfaces of the second channel and the inner side surfaces of the fourth channel and formed in the inner side surfaces of the six third channels forming corners other than the vertices of the second regular hexagon formed by connecting the centers of the third channel; and
a cathode formed in the inner side surface of the electrolyte,
wherein the size and shape of the first channel, the second channel, the third channel, and the fourth channel are the same and the mutual interval thereof is the same.

2. The solid oxide fuel cell as set forth in claim 1, further comprising:
twenty four fifth channels penetrating through the anode support to surround the fourth channel, a fourth virtual line connecting the centers of the twenty four fifth channels forming a concentric fourth regular hexagon by enlarging the first regular hexagon four times; and
thirty sixth channels penetrating through the anode support to surround the fifth channel, a fifth virtual line connecting the centers of the thirty sixth channels forming a concentric fifth regular hexagon by enlarging the first regular hexagon five times;
wherein the size and shape of the first channel, the second channel, the third channel, the fourth channel, the fifth channel, and the sixth channel are the same and the mutual interval thereof is the same; and
the electrolyte is further formed in the inner side surfaces of the six channel and the inner side surfaces of the twelve fifth channels forming corners other than the vertices of the fourth regular hexagon formed by connecting the centers of the fifth channel and the centers of the adjacent vertices thereof.

3. The solid oxide fuel cell as set forth in claim 1, wherein the cross section of the first channel, the cross section of the second channel, the cross section of the third channel, and the cross section of the fourth channel are formed to have a circular shape.

4. The solid oxide fuel cell as set forth in claim 1, wherein the cross section of the first channel, the cross section of the second channel, the cross section of the third channel, and the cross section of the fourth channel are formed to have a hexagonal shape.

5. The solid oxide fuel cell as set forth in claim 2, wherein the cross section of the first channel, the cross section of the second channel, the cross section of the third channel, the cross section of the fourth channel, the cross section of the fifth channel, and the cross section of the sixth channel are formed to have a circular shape.

6. The solid oxide fuel cell as set forth in claim 2, wherein the cross section of the first channel, the cross section of the second channel, the cross section of the third channel, the cross section of the fourth channel, the cross section of the fifth channel, and the cross section of the sixth channel are formed to have a hexagonal shape.

7. The solid oxide fuel cell as set forth in claim 1, further comprising an anode functional layer formed between the outer side surface of the electrolyte and the anode support.

8. The solid oxide fuel cell as set forth in claim 2, further comprising an anode functional layer formed between the outer side surface of the electrolyte and the anode support.

9. The solid oxide fuel cell as set forth in claim 1, further comprising a cathode functional layer formed between the inner side surface of the electrolyte and the cathode.

10. The solid oxide fuel cell as set forth in claim 2, further comprising a cathode functional layer formed between the inner side surface of the electrolyte and the cathode.

11. A solid oxide fuel cell, comprising:
a cathode support formed to have a hexagonal prism shape and having a cross section of a regular hexagon;
a first channel penetrating through the cathode support so that the center of the first channel coincides with the center of the cathode support;
six second channels penetrating through the cathode support to surround the first channel, a first virtual line connecting each of the centers of the six second channels forming a concentric first regular hexagon by reducing the cross section of the cathode support at a predetermined ratio;
twelve third channels penetrating through the cathode support to surround the second channel, a second virtual line connecting the centers of the twelve third channels forming a concentric second regular hexagon by enlarging the first regular hexagon twice;
eighteen fourth channels penetrating through the cathode support to surround the third channel, a third virtual line connecting the centers of the eighteen fourth channels forming a concentric third regular hexagon by enlarging the first regular hexagon three times;
an electrolyte formed in the inner side surfaces of the second channel and the inner side surfaces of the fourth channel and formed in the inner side surfaces of the six third channels forming corners other than the vertices of the second regular hexagon formed by connecting the centers of the third channel; and
a cathode formed in the inner side surface of the electrolyte,
wherein the size and shape of the first channel, the second channel, the third channel, and the fourth channel are the same and the mutual interval thereof is the same.

12. The solid oxide fuel cell as set forth in claim 11, further comprising:
twenty four fifth channels penetrating through the cathode support to surround the fourth channel, a fourth virtual line connecting the centers of the twenty four fifth channels forming a concentric fourth regular hexagon by enlarging the first regular hexagon four times; and
thirty sixth channels penetrating through the cathode support to surround the fifth channel, a fifth virtual line connecting the centers of the thirty sixth channels forming a concentric five regular hexagon by enlarging the first regular hexagon five times;
wherein the size and shape of the first channel, the second channel, the third channel, the fourth channel, the fifth channel, and the sixth channel are the same and the mutual interval thereof is the same; and
the electrolyte is further formed in the inner side surfaces of the six channel and the inner side surfaces of the twelve fifth channels forming corners other than the vertices of the fourth regular hexagon formed by connecting the centers of the fifth channel and the centers of the adjacent vertices thereof.

13. The solid oxide fuel cell as set forth in claim 11, wherein the cross section of the first channel, the cross section of the second channel, the cross section of the third channel, and the cross section of the fourth channel are formed to have a circular shape.

14. The solid oxide fuel cell as set forth in claim 11, wherein the cross section of the first channel, the cross section of the second channel, the cross section of the third channel, and the cross section of the fourth channel are formed to have a hexagonal shape.

15. The solid oxide fuel cell as set forth in claim 12, wherein the cross section of the first channel, the cross section of the second channel, the cross section of the third channel, the cross section of the fourth channel, the cross section of the fifth channel, and the cross section of the sixth channel are formed to have a circular shape.

16. The solid oxide fuel cell as set forth in claim 12, wherein the cross section of the first channel, the cross section of the second channel, the cross section of the third channel, the cross section of the fourth channel, the cross section of the fifth channel, and the cross section of the sixth channel are formed to have a hexagonal shape.

17. The solid oxide fuel cell as set forth in claim 11, further comprising a cathode functional layer formed between the outer side surface of the electrolyte and the cathode support.

18. The solid oxide fuel cell as set forth in claim 12, further comprising a cathode functional layer formed between the outer side surface of the electrolyte and the cathode support.

19. The solid oxide fuel cell as set forth in claim 11, further comprising an anode functional layer formed between the inner side surface of the electrolyte and the anode.

20. The solid oxide fuel cell as set forth in claim 12, further comprising an anode functional layer formed between the inner side surface of the electrolyte and the anode.
